(19) United States
(12) Patent Application Publication
(10) Pub. No.: US 2009/0271127 A1
(43) Pub. Date: Oct. 29, 2009

(54) SYSTEM AND METHOD FOR MONITORING VEHICLE RESIDUAL INTEGRITY

(75) Inventors: Robert Y. Tsang, Toronto (CA); Norman Joseph Weigert, Whitby (CA)

Correspondence Address: INGRASSIA FISHER & LORENZ, P.C. (GM), 7010 E. COCHISE ROAD, SCOTTSDALE, AZ, 85253, US

(73) Assignee: GENERAL MOTORS OF CANADA LIMITED, Oshawa (CA)

(21) Appl. No.: 12/110,116

(22) Filed: Apr. 25, 2008

(51) Int. Cl. G06F 19/00

(52) U.S. Cl. 702/34

(57) ABSTRACT

A vehicle residual integrity monitoring system leverages the existing onboard vehicle computer network architecture and onboard data communication bus to obtain and process data items generated by various vehicle network modules. The data items are generated in response to the occurrence of events that impact residual value of the vehicle or subsystems of the vehicle. The system maintains a residual integrity score that provides an indication of the residual value of the vehicle, based upon a plurality of intelligently processed factors. By monitoring existing onboard network traffic, information is gathered to form new views of the vehicle condition that can be utilized to better approximate the true overall value of the vehicle. This information can supplement conventionally available information (e.g., odometer readings) and serves as an added benefit to the vehicle operator, used car customers, service technicians, and potentially other users.

### TECHNICAL FIELD

The present invention generally relates to onboard electronic vehicle diagnostic systems. More particularly, the present invention relates to an automated onboard system for monitoring vehicle residual integrity.

### BACKGROUND

A vehicle odometer serves to keep track of the accumulated mileage of the vehicle, and the accumulated mileage provides a simple indication of the overall condition and residual value of the vehicle. The use of the odometer as a measure of vehicle “goodness” has widespread ramifications throughout the automotive industry that affect the end consumers, retailers, subsequent purchasers, service centers, and manufacturers.

The overall impression imparted on the casual observer is that a vehicle with higher mileage has been used more and, thus, is most likely “less good” in comparison to an identical vehicle having lower mileage. To a more educated observer, however, it is known that total mileage is only a part of a complex calculation used to determine overall vehicle condition and worth. Factors such as the environment in which the vehicle has been driven, how the vehicle has been driven, and where the vehicle has been driven all affect the true condition of the vehicle. The recent introduction on some vehicles of an “hourmeter” to keep track of cumulative engine run time is tangible evidence that the odometer by itself is but a rough approximation of the true residual value of a vehicle. Adding engine run time to overall mileage is a step toward presenting a more accurate and comprehensive assessment of the condition of a vehicle.

As new automobiles become increasingly electronics-based and microprocessor-controlled, there is a corresponding increase in the amount of vehicle data available on the data communication network employed by the vehicle. For example, engine control modules can monitor information related to engine speed and temperature, and anti-lock brake system (“ABS”) controllers often use sensors to detect wheel speeds for use in connection with the ABS algorithms. In an effort to optimize onboard communication, modern vehicles typically transmit and receive all vehicle data on a common data communication bus. Historically, however, such readily available vehicle data has not been utilized in the context of a vehicle residual monitoring system.

Accordingly, it is desirable to take advantage of an existing vehicle data network to obtain data that might have a bearing on the residual value of the vehicle. A vehicle residual integrity monitoring system can leverage readily available vehicle data generated by various vehicle subsystems or modules, and process such data to provide an accurate assessment of the residual value of the vehicle. Furthermore, other desirable features and characteristics of the present invention will become apparent from the subsequent detailed description and the appended claims, taken in conjunction with the accompanying drawings and the foregoing technical field and background.

### BRIEF SUMMARY

A vehicle residual integrity system according to the invention can be employed as an onboard subsystem in a vehicle having a data communication network. The existing vehicle data communication network and communication protocols need not be modified, and the vehicle residual integrity system is preferably compatible with conventional vehicle data formats. The vehicle residual integrity system provides a more intelligent assessment of the residual value of the vehicle by considering a plurality of factors and events rather than an isolated measurement such as accumulated mileage.

The above and other aspects of the invention may be carried out in one form by a method for monitoring residual integrity of a vehicle. The method involves: monitoring for data items generated in response to the occurrence of events that impact residual value of the vehicle; generating vehicle residual integrity factors (“VRIFs”) in response to the data items; and computing a vehicle residual integrity monitoring (“VRIM”) score based upon the VRIFs.

### BRIEF DESCRIPTION OF THE DRAWINGS

The present invention will hereinafter be described in conjunction with the following drawing figures, wherein like numerals denote like elements, and

FIG. 1 is a schematic representation of an onboard vehicle computing network configured in accordance with an example embodiment of the invention;

FIG. 2 is a schematic data context diagram for a VRIM system configured in accordance with an example embodiment of the invention;

FIG. 3 is a schematic representation of a VRIM processor configured in accordance with an example embodiment of the invention;

FIG. 4 is a flow diagram of a VRIM process which may be performed by a VRIM system configured in accordance with an example embodiment of the invention; and

FIG. 5 is a flow diagram of a VRIM scoring process which may be performed by a VRIM system configured in accordance with an example embodiment of the invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of practical vehicle computer system platforms, architectures, and deployments, and that the particular system described herein is merely one exemplary application for the invention.

For the sake of brevity, conventional techniques related to vehicle computer modules, vehicle data processing, vehicle network data transmission, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to components or features being “connected” or “coupled” together. As used herein, unless expressly stated otherwise, “connected” means that one component/feature is directly or indirectly connected to another component/feature, and not necessarily mechanically. Likewise, unless expressly stated otherwise, “coupled” means that one component/feature is directly or indirectly coupled to another component/feature, and not necessarily mechanically. Thus, although the schematic block diagrams depict example arrangements of elements, additional intervening elements, devices, features, or components may be present in an actual embodiment (assuming that the functionality of the systems or subsystems are not adversely affected).

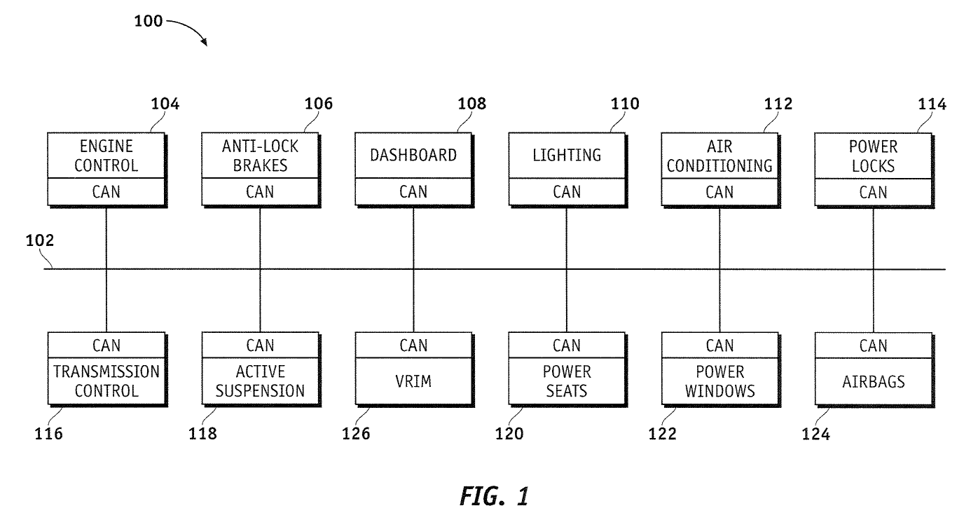

FIG. 1 is a schematic representation of an onboard vehicle computing network 100 configured in accordance with an example embodiment of the invention. Vehicle computing network 100 generally includes a data communication bus 102 and a plurality of electronic control units (“ECUs”), computing modules, processing modules, vehicle data sources, or other network components coupled to data communication bus 102. In a practical embodiment of the invention, the various modules in vehicle computing network 100 are compatible with the controller area network (“CAN”) protocol, which is typically employed in vehicle applications. In this regard, vehicle computing network 100 may include a high speed network portion and a low speed network portion (not separately shown in FIG. 1) to support different modules as necessary.

Vehicle computing network 100 may include, without limitation, any number of the following modules: an engine control module 104; an anti-lock brake (“ABS”) module 106; a dashboard module 108; a lighting module 110; an air conditioning module 112; a power locks module 114; a transmission control module 116; an active suspension module 118; a power seats module 120; a power windows module 122; and an airbag module 124. Each of these modules is associated with a particular function, feature, or operation (or a related group of functions, features, or operation) as indicated by the name of the module. For example, lighting module 110 is associated with the various lighting systems found in a typical vehicle, such as the headlight system, the turn signals, the interior lights, and the brake lights. Vehicle computing network 100 may also include a VRIM system module 126 configured to carry out the functions, techniques, and processes described in more detail below. Generally, a given network module may perform one or more of the following functions in connection with its assigned system (or systems): control or regulate the operation of the system; monitor the operation of the system; perform diagnostic tests on the system; report the operating status of the system; or generate data items associated with the system. In a practical embodiment of the invention, the above-identified modules (with the exception of VRIM system module 126) may be of conventional designs and such modules need not be modified to accommodate the operation of VRIM system module 126 or the VRIM system described herein. In this regard, vehicle computing network 100 may include more or less modules than that shown in FIG. 1.

The modules depicted in FIG. 1 are suitably configured to facilitate vehicle data communication throughout vehicle computing network 100. In practice, such vehicle data communication is performed in compliance with the CAN protocol. At least some of the network modules are configured to generate data items in response to the occurrence of events associated with their respective system or systems, and to provide the data items onto data communication bus 102 for appropriate routing, handling, and processing. As used herein, a “data item” means, for example, a compatible signal, quantity, value, characteristic, or other piece of information that may become available for routing in vehicle computing network 100 or for processing by an element, feature, or component in vehicle computing network 100. As used herein, an “event” means, for example, any detectable, measurable, or observable feature, characteristic, status, condition, movement, or the like, and an “event” may be, for example, physical, mechanical, electrical, magnetic, dynamic, or static in nature.

The monitored events may impact the residual value of the vehicle, and the VRIM system described herein processes data items indicative of these types of events. For example, driving at excessive engine speeds may adversely impact the residual value of the vehicle, and engine control module 104 may generate appropriate data items in response to the detection of excessive engine speed. As another example, an airbag deployment usually results from an accident, and airbag module 124 may generate appropriate data items in response to an airbag deployment. Notably, any number of otherwise unrelated or innocuous individual events may, in combination, indicate a more general or “higher level” event that may adversely impact the residual value of the vehicle. For example, applying the parking brake while the vehicle is in motion is detrimental to the braking and power train systems. In this regard, lower level event data, which may be generated from engine control module 104 and a brake system module (not shown), can be processed by VRIM system module 126 in an appropriate manner. Indeed, a practical VRIM system module 126 may leverage existing technologies related to data fusion, artificial intelligence, neural networking, evolutionary computing, or the like for purposes of processing and interpreting event data at any level. It should be appreciated that VRIM system module 126, and any corresponding logical elements, individually or in combination, are example means for monitoring the data items.

In a practical embodiment, VRIM system module 126 may include logical or functional elements realized by hardware, software, firmware, or any combination thereof, such as one or more processors, controllers, network communication ports, memory elements, or the like. In accordance with the practices of persons skilled in the art, embodiments of the invention may be described herein with reference to symbolic representations of operations that may be performed by various logical, functional, or processor-based components. Such operations are sometimes referred to as being computer-executed, computerized, software-implemented, or computer-implemented. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (“EROM”), a floppy diskette, a CD-ROM or any optical disk, a hard disk, a fiber optic medium, a radio frequency (“RF”) link, or the like. Data signals referred to herein may include any signal that can propagate over a transmission medium such as electronic network channels, optical fibers, air, electromagnetic paths, or RF links.

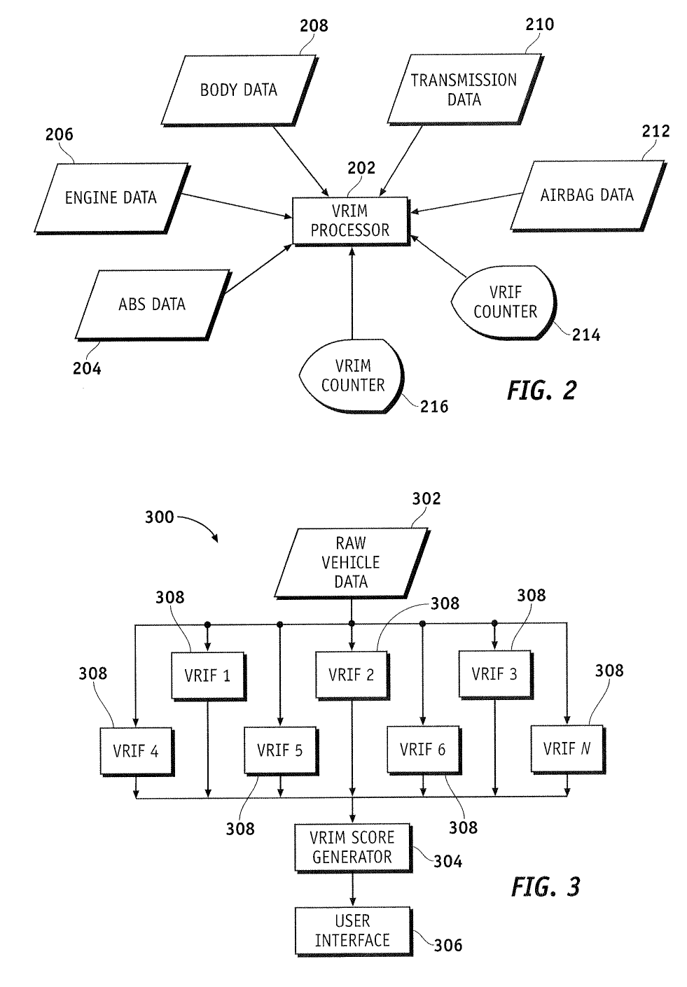

FIG. 2 is a schematic data flow diagram for a VRIM system configured in accordance with an example embodiment of the invention. This data flow diagram depicts an example data flow pattern for VRIM system module 126. Generally, FIG. 2 shows a VRIM processor 202 receiving or processing data items associated with different network modules, and shows VRIM processor 202 providing data to one or more user interface elements in the vehicle. VRIM processor 202 may be realized as any suitable computer processor or controller having the programmed intelligence to carry out the functions described herein. VRIM processor 202 may receive data items originating from or otherwise associated with one or more network modules. For example, VRIM processor 202 may receive and process one or more of: ABS related data 204, engine related data 206, body related data 208, transmission related data 210, and/or airbag related data 212. VRIM processor 202 may additionally or alternatively receive and process any amount of data items originating from or otherwise associated with any of the network modules shown in FIG. 1. It should be appreciated that these example lists are not exhaustive, and that FIG. 2 only depicts several example data types for illustrative purposes. Furthermore, it should be appreciated that VRIM processor 202, and any corresponding logical elements, individually or in combination, are example means for monitoring the data items.

VRIM processor 202 may be suitably configured to communicate with one or more user interface elements such that the user interface elements can convey information related to the vehicle residual integrity. For example, VRIM processor 202 may provide rendering data for a vehicle residual integrity factor (“VRIF”) counter 214 and/or a VRIM counter 216, where such counters can be realized on a suitable display element or other user interface in the vehicle. The significance of these counters is explained in more detail below. In a practical implementation, VRIF counter 214 and VRIM counter 216 can be rendered on an otherwise conventional or standard vehicle display screen, and the rendering data or control instructions generated by VRIM processor 202 are formatted in an appropriate manner.

FIG. 3 is a schematic representation of a VRIM processor 300 configured in accordance with an example embodiment of the invention. Briefly, VRIM processor 300 is configured to process raw vehicle data items 302 to generate a VRIM score (or a plurality of VRIM scores) that can be communicated to an operator of the VRIM system, e.g., a driver of the vehicle, a service technician, the vehicle manufacturer, or a used car customer. VRIM processor 300 may include a VRIM score generator 304 that computes the VRIM score, and VRIM processor 300 may be coupled to a user interface 306 deployed in the vehicle, where user interface 306 is configured to display the VRIM score generated by VRIM score generator 304.

Generally, VRIM processor 300 is configured to monitor raw data present on the vehicle network communication bus and to process data items relevant to the residual value of the vehicle. In this regard, VRIM processor 300 functions as a data “sniffer” that need not be concerned with some of the raw data present on the vehicle network communication bus, and VRIM processor 300 may contain the appropriate logic to enable it to recognize the relevant data items flowing through the vehicle network communication bus. VRIM processor 300 processes the relevant raw data items and generates one or more VRIFs in response to the raw data items. As used herein, a “VRIF” is data that represents a quantity, value, number, or other item of information that contributes to diminishing overall vehicle condition, residual value, worth, or “goodness.” In the example VRIM system described herein, a VRIF represents data (having an intermediate level relative to the low level raw data items) that contributes to the overall VRIM score for the vehicle. The number of VRIFs monitored by a given VRIM system may vary from vehicle to vehicle. VRIM processor 300 also processes the VRIFs and computes one or more VRIM scores based upon the VRIFs. In this regard, VRIM processor 300 may be configured to adjust the VRIM score or scores by an amount that is dictated, controlled, or influenced by one or more of the VRIFs. As used herein, a “VRIM score” is data that represents a quantity, value, number, or other item of information that indicates the condition, residual value, worth, or “goodness” of the vehicle (or a portion or subsystem of the vehicle). In accordance with one practical embodiment of the invention, an overall VRIM score for a vehicle is represented by a numerical count, where a new vehicle begins its life with a count of zero and the overall VRIM score increases as the residual integrity of the vehicle decreases. In this regard, the VRIM score is analogous to an odometer or hourmeter count.

VRIM processor 300 may include any number of VRIF processors 308 configured to generate any number of VRIFs in response to data items 302. FIG. 3 schematically depicts VRIF processors 308 as logical elements that generate their respective VRIFs and provide their respective VRIFs to VRIM score generator 304. In this regard, VRIM processor 300, VRIF processors 308, and any corresponding logical elements, individually or in combination, are example means for generating the VRIFs. In a practical implementation, VRIF processors 308 and VRIM score generator 304 may be realized in a single processing unit. Each VRIF processor 308 may utilize a suitable algorithm that determines, from the raw data items, whether the occurrence of one or more events should trigger the generation of the respective VRIF. In this regard, VRIM processor 300, VRIF processors 308, and any corresponding logical elements, individually or in combination, are example means for monitoring data items 302. Furthermore, VRIM module 126, VRIM processor 300, VRIM score generator 304, and any corresponding logical elements, individually or in combination, are example means for computing a VRIM score based upon a plurality of VRIFs. The VRIF algorithms may also be designed to determine the value of the respective VRIF, when to provide the VRIF to VRIM score generator 304, whether to save the VRIF value, or the like.

A given VRIF algorithm may be simple or complex, depending upon the particular application. For example, a VRIF algorithm may be time dependent and/or distance dependent. One practical VRIF relates to the monitoring of engine revolutions per minute (“RPM”) to determine if the vehicle typically exceeds a certain engine speed. A more complex VRIF algorithm may combine several simple VRIFs to form a more comprehensive view of the vehicle condition. For example, one complex VRIF algorithm ascertains whether the driver typically operates the vehicle with the parking brake engaged over a specified distance while the vehicle is moving—such a complex VRIF algorithm may require data items from a plurality of sources. A number of practical VRIFs suitable for use in an actual deployment are described below, and a practical embodiment of the invention may utilize any number of these VRIFs, any number of additional VRIFs, and/or any number of alternative VRIFs, depending upon the particular implementation.

Rolling Distance Count

This VRIF is based on the premise that mileage adversely impacts the residual value of the vehicle (this VRIF is somewhat equivalent to an odometer reading). As one example, the VRIM processor may increment the VRIM count for every 1000 miles detected.

Airbag Deployed

This VRIF is based on the premise that a deployed airbag typically indicates that some physical damage has occurred to the vehicle. This VRIF might monitor for a suitably formatted “airbag deployed” signal or data item generated by the networked airbag module. As one example, the VRIM processor may increment the VRIM count if an airbag is deployed.

Extended Idling

This VRIF is based on the premise that extended idling is hard on the power train, the charging system, and possibly other vehicle subsystems. This VRIF may be based upon data items related to engine run status and time duration. As one example, the VRIM processor may increment the VRIM count if engine idling is detected for more than a specified time period.

Parking Brake Engaged While Moving

This VRIF is based on the premise that extended driving with the parking brake engaged prematurely degrades the parking brake system. This VRIF may be based upon data items related to parking brake status, vehicle speed, and time duration. As one example, the VRIM processor may increment the VRIM count if the parking brake is engaged, if the vehicle speed exceeds a threshold speed, and if more than a specified time period has elapsed.

Extended ABS Event

This VRIF is based on the premise that extended deployment of ABS is indicative of aggressive driving behavior. This VRIF may be based upon data items related to ABS status and time duration. As one example, the VRIM processor may increment the VRIM count if ABS is active for more than a threshold number of seconds at a time, or if ABS is active for more than a threshold percentage of driving time.

High Engine Speed While Cold

This VRIF is based on the premise that driving aggressively before the engine has reached a normal operating temperature is detrimental to the power train. This VRIF may be based upon data items related to engine coolant temperature and engine speed. As one example, the VRIM processor may increment the VRIM count if the engine coolant temperature is below a threshold temperature and if the engine speed is greater than a threshold RPM.

Extended High Engine Speed

This VRIF is based on the premise that operating at high engine speed for extended periods is detrimental to the power train. This VRIF may be based upon data items related to engine speed, distance traveled, and time duration. As one example, the VRIM processor may increment the VRIM count if the engine speed is greater than a threshold RPM, if the distance traveled is greater than a threshold length, and if more than a specified time period has elapsed.

Two-Foot Driving

This VRIF is based on the premise that applying the brakes while the throttle pedal is still engaged causes premature wear to the brake system and adds unnecessary power train loading. This VRIF may be based upon data items related to brake pedal engagement, throttle pedal engagement, transmission gearing, and distance traveled. As one example, the VRIM processor may increment the VRIM count if the brake pedal is active, if the throttle position is greater than a threshold value, if the transmission gear status is other than “park,” and if the distance traveled is greater than a threshold length.

City Versus Highway Driving

This VRIF is based on the premise that operating at stop-and-go (i.e., city driving) negatively affects the power train. This VRIF may be based upon data items related to engine speed, transmission gearing, vehicle speed, and time duration. As one example, the VRIM processor may increment the VRIM count if a weighted average of engine speed is greater than a threshold RPM, if a weighted average of vehicle speed is greater than a threshold velocity, if the transmission gear status is other than “park,” and if more than a specified time period has elapsed.

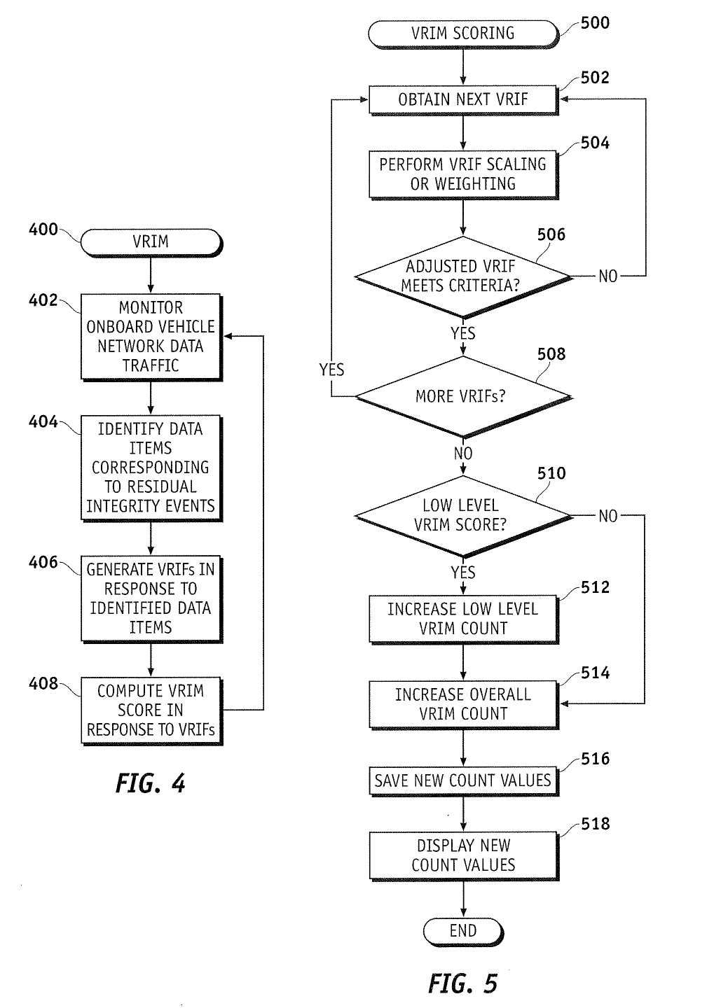

FIG. 4 is a flow diagram of a VRIM process 400 which may be performed by a VRIM system configured in accordance with an example embodiment of the invention. The various tasks performed in connection with process 400 may be performed by software, hardware, firmware, or any combination thereof. For illustrative purposes, the following description of process 400 may refer to elements mentioned above in connection with FIGS. 1-3. In practical embodiments, portions of process 400 may be performed by different elements of the described system, e.g., VRIM system module 126, VRIM processor 300, VRIF processors 308, or VRIM score generator 304. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein.

VRIM process 400 monitors the onboard vehicle network data traffic (task 402) for the presence of relevant data items. Specifically, task 402 monitors for data items generated in response to the occurrence of certain events that impact residual value of the vehicle. In the example embodiment, the monitored data items may be generated in response to the occurrence of various events, including, without limitation: events related to vehicle drive train status; events related to vehicle chassis status; events related to vehicle body status; events related to vehicle electrical system status; events related to vehicle safety system status; events related to vehicle climate control system status; events related to any of the modules shown in FIG. 1, events associated with any of the data items shown in FIG. 2, or any of the example events described above. In practice, VRIM system module 126 can monitor the vehicle network in a passive manner that does not otherwise affect the normal operation of the other network modules or the normal operation of the vehicle computing network. While monitoring the network data traffic, VRIM process 400 may identify the data items corresponding to residual integrity events (task 404). In this regard, VRIM processor 300 and/or the individual VRIF processors 308 may be suitably configured to identify, detect, or otherwise recognize the relevant data items.

Assuming that one or more relevant data items have been identified, VRIM process 400 can generate one or more VRIFs in response to the identified data items (task 406), and compute a VRIM score based upon the VRIFs (task 408). The VRIM score may be indicative of a current overall residual value of the vehicle, or indicative of a current residual value for a subsystem or other portion of the vehicle. VRIM process 400 may be performed in an ongoing manner to provide real-time updating of the VRIM scores. Thus, VRIM process 400 is depicted as a loop in FIG. 4.

FIG. 5 is a flow diagram of a VRIM scoring process 500 which may be performed by a VRIM system configured in accordance with an example embodiment of the invention. The various tasks performed in connection with process 500 may be performed by software, hardware, firmware, or any combination thereof. For illustrative purposes, the following description of process 500 may refer to elements mentioned above in connection with FIGS. 1-3. In practical embodiments, portions of process 500 may be performed by different elements of the described system, e.g., VRIM system module 126, VRIM processor 300, VRIF processors 308, VRIM score generator 304, or user interface 306. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein.

VRIM scoring process 500 represents an example implementation of tasks 406 and 408 described above in connection with FIG. 4. It should be appreciated that alternate techniques and VRIM scoring algorithms may be employed in a practical embodiment. Process 500 begins by obtaining the next VRIF available for processing (task 502). The VRIF may be subjected to an appropriate scaling or weighting function (task 504) such that it has the desirable amount of influence on the VRIM score. If the adjusted VRIF meets a predetermined criteria (query task 506), then process 500 proceeds to a query task 508. In the example embodiment, query task 506 may compare characteristics of the data items to criteria indicative of residual value of the vehicle. The criteria may, for example, be a threshold VRIF value that determines whether the given VRIF should be considered for purposes of the VRIM count or whether the given VRIF should be disregarded. Alternatively, the criteria may include temporal aspects of the VRIF, may be associated with an accumulated VRIF value, or may consider other factors that indicate whether the event associated with the VRIF adversely affects the residual value of the vehicle. If the adjusted VRIF does not meet the criteria, then task 502 may be re-entered to obtain a different VRIF for processing.

Assuming that the current VRIF meets the designated criteria, then query task 508 determines whether more VRIFs need to be analyzed. If additional VRIFs remain, then process 500 is re-entered at task 502 to obtain the next VRIF. If, however, all VRIFs for the current iteration have been analyzed, then process 500 leads to a query task 510, which checks whether the VRIM system monitors a “low level” VRIM score indicative of a current residual value for a subsystem or a portion of the vehicle. If so, then process 500 adjusts a low level VRIM score by an amount dictated by the previously analyzed VRIFs. In the example embodiment, process 500 increases the low level VRIM count by an appropriate amount governed by the VRIFs (task 512). For example, the low level VRIM count may be a simple numerical value that is only slightly increased for relatively innocuous events, and increased by a relatively large amount for events that greatly impact the residual integrity of the respective vehicle subsystem. In addition to task 512 (or if query task 510 determines that low level VRIM scoring is not enabled), process 500 may adjust the overall VRIM score by an amount dictated by the previously analyzed VRIFs. In the example embodiment, process 500 increases the overall VRIM count by an appropriate amount governed by the VRIFs (task 514). For example, the overall VRIM count may be a simple numerical value that is only slightly increased for relatively innocuous events, and increased by a relatively large amount for events that greatly impact the residual integrity of the vehicle.

In practice, once the VRIM scores have been updated, the VRIM system saves the VRIM scores or VRIM count values in a secure manner (task 516). The updated VRIM scores are preferably stored in a suitable onboard memory location in a manner that prevents tampering and access by unauthorized persons. In practice, the updated VRIM scores may be stored as “read only” data in a suitable memory location of the vehicle computer network. Preserving the integrity and validity of the current VRIM scores can be an important aspect of a VRIM system because the VRIM scores are intended to provide an accurate and honest assessment of the residual value of the vehicle. The new VRIM counts may also be displayed on user interface 306 or on any suitable instrument in the vehicle (task 518). For example, the VRIM count displays may be incorporated into an otherwise conventional dashboard display panel.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for monitoring residual integrity of a vehicle, said method comprising:
monitoring for data items generated in response to the occurrence of events that impact residual value of the vehicle;
generating vehicle residual integrity factors (“VRIFs”) in response to said data items; and
computing a vehicle residual integrity monitoring (“VRIM”) score based upon a plurality of said VRIFs.

2. A method according to claim 1, said data items being included in onboard vehicle network data traffic.

3. A method according to claim 1, wherein generating VRIFs comprises comparing characteristics of said data items to predetermined criteria indicative of residual value of the vehicle.

4. A method according to claim 1, wherein computing said VRIM score comprises adjusting a VRIM count by an amount dictated by said VRIFs.

5. A method according to claim 4, said VRIM count being indicative of a current overall residual value for the vehicle.

6. A method according to claim 4, said VRIM count being indicative of a current residual value for a subsystem of the vehicle.

7. A method according to claim 1, at least a portion of said data items being generated in response to the occurrence of events related to vehicle drive train status.

8. A method according to claim 1, at least a portion of said data items being generated in response to the occurrence of events related to vehicle chassis status.

9. A method according to claim 1, at least a portion of said data items being generated in response to the occurrence of events related to vehicle body status.

10. A method according to claim 1, at least a portion of said data items being generated in response to the occurrence of events related to vehicle electrical system status.

11. A method according to claim 1, at least a portion of said data items being generated in response to the occurrence of events related to vehicle safety system status.

12. A method according to claim 1, at least a portion of said data items being generated in response to the occurrence of events related to vehicle climate control system status.

13. A method according to claim 1, further comprising saving said VRIM score in a secure manner.

14. A method according to claim 1, further comprising rendering said VRIM score on an onboard display element.

15. A system for monitoring residual integrity of a vehicle, said system comprising:
means for monitoring data items generated in response to the occurrence of events that impact residual value of the vehicle;
means for generating vehicle residual integrity factors (“VRIFs”) in response to said data items; and
means for computing a vehicle residual integrity monitoring (“VRIM”) score based upon a plurality of said VRIFs.

16. A system according to claim 15, said means for generating being configured to compare characteristics of said data items to predetermined criteria indicative of residual value of the vehicle.

17. A system according to claim 15, said means for computing being configured to adjust a VRIM count by an amount dictated by said VRIFs.

18. A computer program architecture for monitoring residual integrity of a vehicle, said computer program architecture being embodied on computer-readable media, said computer program architecture having computer-executable instructions comprising:
instructions for monitoring data items generated in response to the occurrence of events that impact residual value of the vehicle;
instructions for generating vehicle residual integrity factors (“VRIFs”) in response to said data items; and
instructions for computing a vehicle residual integrity monitoring (“VRIM”) score based upon a plurality of said VRIFs.

19. A system for monitoring residual integrity of a vehicle, said system comprising:
an onboard vehicle computing network comprising a plurality of electronic control units (“ECUs”) coupled to a data communication bus, said ECUs being configured to provide data items onto said data communication bus, said data items being generated in response to the occurrence of events that impact residual value of the vehicle;
a vehicle residual integrity monitor (“VRIM”) module coupled to said data communication bus, said VRIM module being configured to receive said data items, generate vehicle residual integrity factors (“VRIFs”) in response to said data items, and compute a vehicle residual integrity score based upon a plurality of said VRIFs; and
a user interface coupled to said VRIM module, said user interface being configured to communicate said VRIM score.

20. A system according to claim 19, said VRIM module being configured to adjust said VRIM score by an amount dictated by said VRIFs.

21. A system according to claim 19, said user interface being configured to display said VRIM score.
